(19) United States
(12) Patent Application Publication
(10) Pub. No.: US 2015/0175056 A1
(43) Pub. Date: Jun. 25, 2015

(54) AUTO LIGHT SYSTEM AND METHOD OF CONTROLLING THE SAME

(71) Applicants: Hyundai Motor Company, Seoul (KR); Omron Automotive Electronics Korea Co., Ltd., Anseong-si (KR)

(72) Inventors: Ik Jun JANG, Ulsan (KR); Sang Hyun KIM, Gwangmyeong-si (KR); Sang Su LEE, Seoul (KR)

(21) Appl. No.: 14/478,911

(22) Filed: Sep. 5, 2014

(30) Foreign Application Priority Data
Dec. 24, 2013 (KR) 10-2013-0162013

(51) Int. Cl. B60Q 1/14; B60Q 1/22

(52) U.S. Cl. CPC B60Q 1/1423; B60Q 1/1446; B60Q 1/22

(57) ABSTRACT

An auto light system for automatically controlling driving of a vehicular lamp according to an external light level includes an auto light sensor configured to receive light and detect an irradiance of the light. A controller is configured to compare the irradiance detected by the auto light sensor with a reference value to switch on and off a lamp of a vehicle. An input is provided such that a user performs manipulation for changing the reference value. If the user performs the manipulation input for changing the reference value through the input, the controller receives a signal according to the manipulation input by the user, changes the reference value, and stores the changed reference value.

### CROSS-REFERENCE TO RELATED APPLICATION

This application claims under 35 U.S.C. §119(a) the benefit of priority to Korean Patent Application No. 10-2013-0162013, filed on Dec. 24, 2013, the entire contents of which are incorporated herein by reference.

### TECHNICAL FIELD

The present disclosure relates to an auto light system, and more particularly, to an auto light system for automatically controlling driving of a vehicular lamp according to an external light level and a method of controlling the same.

### BACKGROUND

Today, as the automobile industry and the electronics industry have been developing, various devices for providing convenience and safety to drivers are provided in vehicles.

As one of the devices for convenience and safety, an auto light system for detecting an external light level, and automatically switching on or off a vehicular lamp such as a head lamp or a tail lamp or adjusting the light level of the vehicular lamp without additional manipulation of a driver is known.

The auto light system automatically switches on or off the vehicular lamp without manually switching by the driver according to the external light level when irradiance is changed while driving through a tunnel or driving in the snow, rain, or fog, thus improving convenience for the driver, driving safety, and product value of the vehicle.

As shown in FIG. 1, the auto light system includes an auto light switch 11 for switching on or off an auto light function, an auto light sensor 12 for detecting an external light level, and a controller 20 for comparing a detection value of the auto light sensor 12 and outputting a control signal according to the comparison result. A lamp driver 30 switches on or off a vehicular lamp 40 such as a head lamp 41 and a tail lamp 42 according to the control signal of the controller 20.

For example, the auto light switch 11 is provided in a multifunctional switch, and when the auto light switch 11 is switched to an “Auto” position, an auto light function is activated.

The auto light sensor 12 is a sensor for detecting a light level (irradiance). It converts an optical signal into an electric signal, transfers to the controller 20, and outputs the electrical signal (voltage) proportional the light level of the external light using a photoelectric conversion element such as a photodiode. The auto light sensor 12 is generally installed inside a windshield glass (front surface). The auto light sensor 12 applied to a general vehicle receives light of wavelengths of 700 nm to 1100 nm of solar light. That is, the auto light sensor 12 blocks visual rays of solar light and receives and measures only infrared rays (a detected wavelength band: infrared rays of 700 nm to 1100 nm).

The controller 20 controls the lamp driver 30 in response to the external light level measured by the auto light sensor 12 to selectively switch on or off the vehicular lamp 40 (controls driving of the lamp). The controller 20 of the auto light system is a body control module (BCM) in the general vehicle, and compares the irradiance detected by the auto light sensor 12 with a reference value and outputs a control signal for switching on the lamp 40 when the irradiance is lower than the reference value.

The lamp driver 30 switches on or off the vehicular lamp 40 such as a head lamp 40 or a tail lamp 42 according to a control signal of the controller 20 and may include a relay for interrupting electric power of a battery to the lamps.

The solar light includes ultraviolet rays (400 nm or below), visual rays (400 nm to 700 nm), and infrared rays (700 nm or above), and the external light level is determined by human beings according to the amount of visual rays.

However, the auto light system of FIG. 1 controls switching on or off of the vehicular lamp 40 by using only infrared rays as a determination reference of an external light level.

That is, in the auto light sensor 12, a photodiode that is a photoelectric conversion element, may detect light of 400 nm to 1100 nm, but since a sensor cover blocks visual rays and transmits only light of wavelengths (700 nm to 1100 nm) of infrared rays to a photo diode before the light reaches the photo diode, an external light level can be measured only by the infrared rays.

According to an auto light sensor disclosed in Korean Patent No. 10-0871052 (Nov. 21, 2008), a body (sensor cover) of a sensor transmits only infrared rays while shielding visual rays. Thus, the conventional auto light system has the following problems.

There is a time variance between a sensor output and a switching on or off a lamp in the auto light system, which significantly deviates according to the external environment such as season or weather.

For example, the vehicular lamp is not switched off in a shade of a building or after driving through a tunnel during sunrise in the winter season, and switching off of the vehicular lamp may be delayed in cloudy days.

In a vehicle having a tinted windshield glass, the vehicular lamp is switched on early and is not switched off at a correct time point, and thus, time deviations in switching on/off of the auto light sensor vary according to a type (a light transmission rate of glass and the like) of the wind shield glass. Drivers express their dissatisfaction due to the time deviations in switching on/off of the lamp according to the environment.

### SUMMARY OF THE DISCLOSURE

The present disclosure has been made in an effort to solve the above-described problems. An aspect of the present disclosure provides an auto light system that allows a driver to set a time for switching on/off of a vehicular lamp according to the environment, and a method of controlling the same.

Another aspect of the present disclosure provides an improved auto light system that switches on and off a vehicular lamp at correct times by addressing the above-mentioned problem in which a light receiver (photodiode) of an auto light sensor detects only infrared rays to output electrical signals.

In accordance with an embodiment of the present invention, an auto light system includes an auto light sensor configured to receive light and to detect an irradiance of the light. A controller is configured to compare the irradiance detected by the auto light sensor with a reference value to switch on and off a vehicle lamp. An input is provided such that a user performs manipulation for changing the reference value. If the user performs the manipulation for changing the reference value through the input, the controller receives a signal according to the manipulation by the user, changes the reference value, and stores the changed reference value.

In accordance with another embodiment of the present invention, a method of controlling an auto light system includes performing manipulation for changing a reference value by a user through an input. A signal is received according to the manipulation input by the user, the reference value is changed, and the changed reference value is stored by a controller. An irradiance detected by the auto light sensor is compared with the changed reference value to determine a switching on or off time of a vehicle lamp and output a control signal for switching on or off of the vehicle lamp by the controller. The vehicle lamp is switched on or off according to the control signal output by the controller.

According to the present disclosure, the auto light system variably allows a driver to set reference values of a controller by steps according to the environment to adjust switching on/off time of a vehicle lamp so that the vehicle lamp can be switched on or off at a right time.

Further, since the auto light sensor receives light of wavelength bands of visual rays and measures an external light level, measurement accuracy can be increased in various environments as compared with the conventional case of using infrared rays.

### BRIEF DESCRIPTION OF THE DRAWINGS

The above and other features of the present disclosure will now be described in detail with reference to certain exemplary embodiments thereof illustrated by the accompanying drawings which are given hereinafter by way of illustration only, and thus are not limitative of the present invention.

FIG. 1 is a block diagram showing a conventional auto light system.

FIG. 2 is a view depicting decrease rates for wavelengths of light according to a change of weather.

FIG. 3 is a view representing that a switching-off delay of a vehicular lamp is generated after a windshield glass is tinted according to the related art.

FIG. 4 is a perspective view showing an auto light sensor in an auto light system according to an embodiment of the present invention.

FIG. 5 is a view depicting light receiving characteristics of a photodiode, a sensor cover, and a sensor in an auto light system according to an embodiment of the present invention.

FIG. 6 is a diagram including an input for variably setting a reference value in an auto light system according to an embodiment of the present invention.

FIGS. 7A and 7B are views showing an exemplary example of allowing a user to change and select a switching-on/off time point of an auto light system step by step.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, an exemplary embodiment of the present invention will be described in detail with reference to the accompanying drawings so that those skilled in the art to which the present disclosure pertains can easily carry out an embodiment.

An auto light system according to an embodiment of the present invention improves an auto light sensor such that the auto light sensor receives visual rays to determine an external light level from the visual rays, and allows a user (driver) to arbitrarily set a reference value of a controller for determining switching-on/off of a vehicular lamp.

Since an amount of the visual rays in solar light is greater than an amount of the infrared rays, and the amount of the visual rays decreases at a low rate by the external environment, the auto light system according to an embodiment of the present invention changes a determination reference of an external light level (a measurement object compared with the reference in determining switching-on/off of the vehicular lamp) from the infrared rays to the visual rays.

That is, the auto light sensor receives the visual rays as a main element for allowing a person to recognize brightness of light, so that an external light level is determined from the measured visual rays, and a time point for switching on-off of the vehicular lamp is determined.

According to an influence of solar light on the weather change, irradiances of both a visual ray area and an infrared ray area decrease in cloudy weather, where a decrease rate in irradiance of the visual ray area is lower than that of the infrared ray area under the same condition.

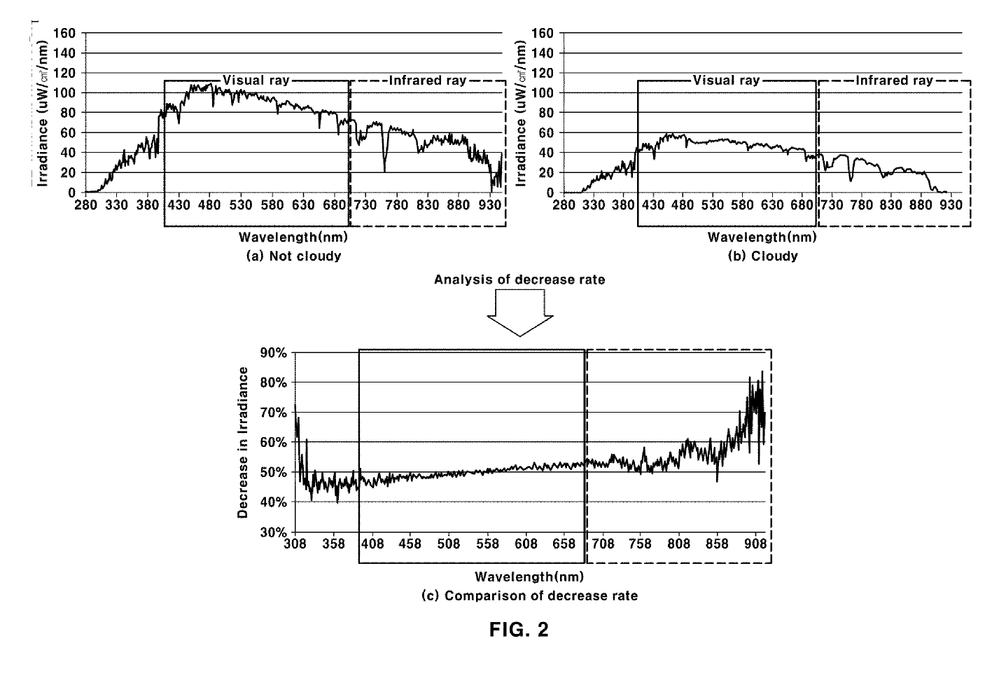

FIG. 2 is a view depicting decrease rates for wavelengths of light according to a change in weather. Referring to FIG. 2, it can be seen that irradiance is high in a visual ray area rather than in an infrared ray area. In particular, a decrease rate in irradiance of the visual ray area is lower than a decrease rate in irradiance of the infrared ray area.

According to a study for an influence of season changes, “Experimental study of solar spectrum impact on solar cells” X. Song, E. Miller and D. Garmire, Nanotech Conference & Expo 2010″, when rates in irradiance decrease for wavelengths according to a change in altitude of the sun, a decrease rate in irradiance in a visual ray area is lower than a rate decrease in irradiance in an infrared ray area and irradiance in the visual ray area is higher than the irradiance in the infrared ray area.

In addition, according to output deviations of the auto light sensor according to a type of vehicle glass, a difference in infrared ray transmission rates according to the glass type is larger than a difference in visual ray transmission rates. In particular, since the infrared ray transmission decrease rate is greater than the visual ray transmission decrease rate in a specific type, a conventional auto light system that measures infrared rays generates significantly large output deviations according to the glass type.

For example, Table 1 below compares transmission decrease rates of visual rays and infrared rays. When windshield glass is changed from a non-solar windshield glass to a sunlight shielding solar windshield glass, a transmission rate of the visual rays decreases slightly, but a transmission rate of the infrared rays decreases significantly.

TABLE 1

| | Visual rays | | Sunlight | | Infrared rays | |
|---|---|---|---|---|---|---|
| | Transmission | Reflection | Transmission | Reflection | Transmission | Reflection |
| Classification | rate (%) | rate (%) | rate (%) | rate (%) | rate (%) | rate (%) |
| Non-solar | 80.9 | 6.9 | 61.7 | 5.8 | 36.5 | 4.9 |
| glass | | | | | | |
| Solar glass | 70.0 | 5.8 | 42.5 | 4.8 | 22.1 | 4.0 |
| Decrease | 13.5 | 15.9 | 34.4 | 17.2 | 39.5 | 18.4 |
| rate | | | | | | |

Further, the auto light system for measuring infrared rays according to the related art may generate a switching on/off delay of the vehicular lamp according to whether or not the glass is tinted. Referring to Table 2 below, when the glass is tinted, a decrease in the infrared ray transmission is larger than a decrease in the visual ray transmission.

TABLE 2

| | | After tinting (Film |
|---|---|---|
| Classification | Before tinting | transmission rate 75%) |
| Infrared ray transmission rate | 100% | 30% |
| Visual ray transmission rate | 75% | 56% |

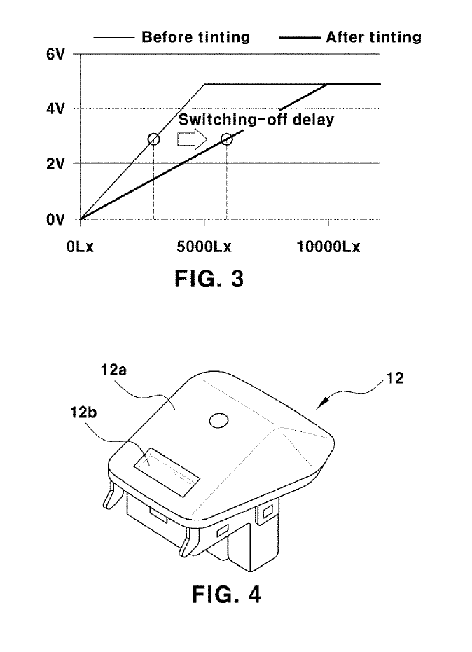

As a result, in a vehicle, to which the auto light system for receiving and measuring only infrared rays according to the related art is applied, a switching-off delay of a vehicular lamp may be generated after windshield glass is tinted as shown in FIG. 3.

The auto light system according to an embodiment of the present invention improves a method of measuring an external light level to a method of receiving visual rays to measure an external light level.

Thereto, a light receiver that receives only light of wavelengths of visual rays (e.g., 400 nm to 700 nm) is used instead of the conventional light receiver (photodiode) that receives light of wavelengths of the visual rays and infrared rays (e.g., 400 nm to 1100 nm), and a sensor cover includes a transparent window for transmitting the visual rays as well as the infrared rays.

FIG. 4 is a perspective view showing an auto light sensor in an auto light system according to an embodiment of the present invention. The sensor cover 12a of an auto light sensor 12 includes a transparent window 12b which prevents visual rays from being shielded by the cover and may transmit the visual rays as well as the infrared rays. A light receiver installed in the auto light sensor 12 is a photodiode for the visual rays that may detect only the visual rays (for example, 400 nm to 700 nm).

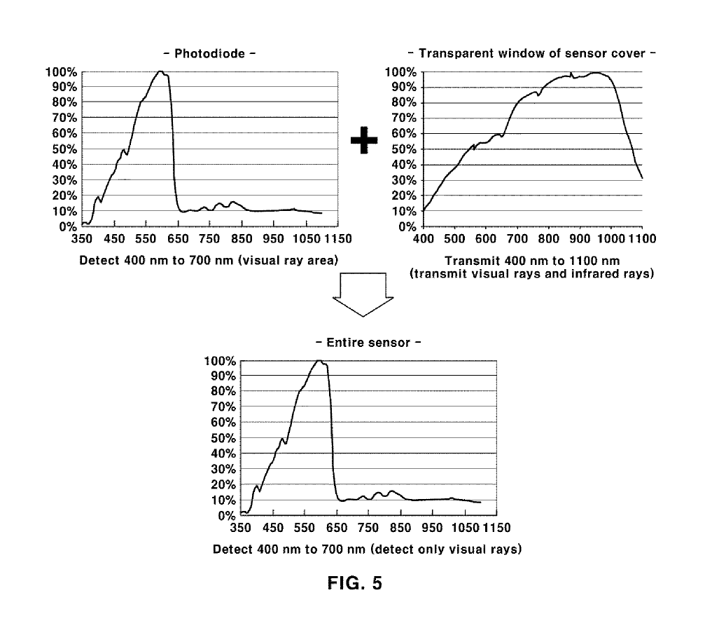

FIG. 5 is a view depicting light receiving characteristics of a photodiode, a sensor cover, and a sensor product in an auto light system according to an embodiment of the present invention. The auto light system employs a photodiode that may detect visual rays of 400 nm to 700 nm as a light receiver and a transparent window installed in the sensor cover, for transmitting the visual rays and infrared rays of 400 nm to 1100 nm such that the visual rays of 400 nm to 700 nm may be detected by the sensor.

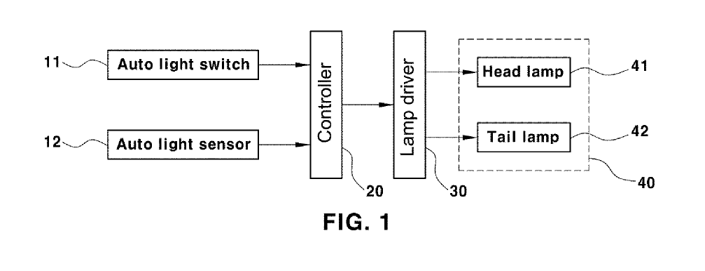

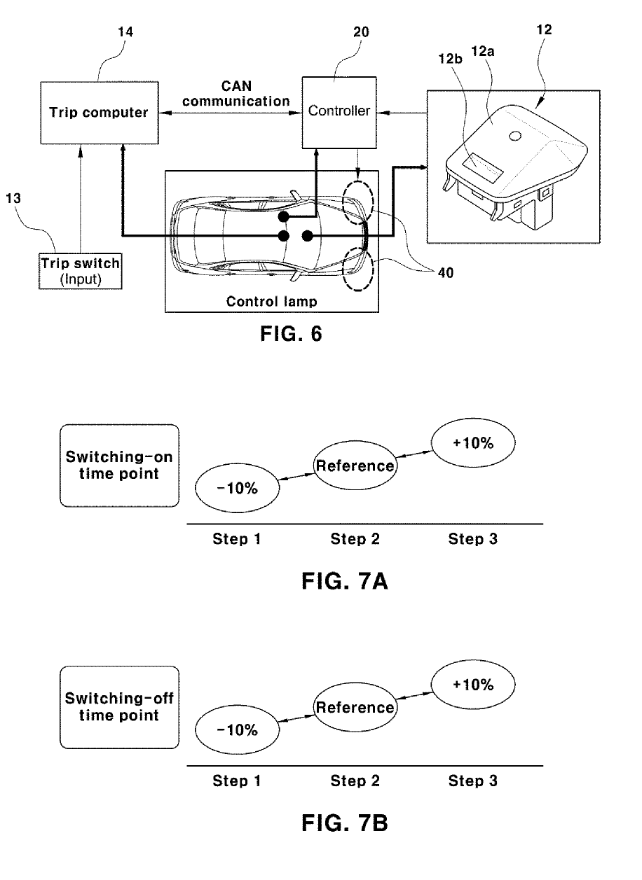

FIG. 6 is a diagram including an input for variably setting a reference value in an auto light system according to an embodiment of the present invention. As shown, the auto light system according to an embodiment of the present invention includes an auto light sensor 12 for receiving light of a visual ray wavelength band and outputting an electrical signal according to an external light level. A controller (BCM) 20 receives the electrical signal of the auto light sensor 12, compares the external light level (an irradiance obtained by measuring visual rays) according to the electrical signal with the reference value, and controls a vehicular lamp 40 (a head lamp or a tail lamp) through a lamp driver (reference numeral 30 of FIG. 1).

The auto light system according to an embodiment of the present invention includes an input 13 for allowing a user to set and change the reference value stored in the controller 20 by stages according to season, weather, an in-use area (for example, may be an altitude of the in-use area, considering a difference in solar light according to the altitude), a type of glass (for example, solar or non-solar) or tinting of glass. The variable reference value of the controller 20 determines switching-on/off of the vehicular lamp 40.

The reference value may be changed through the input to adjust an on/off control time point of the vehicular lamp if necessary according to an in-use condition other than the season, weather, in-use area, kind of glass, and tinting. The reference value may be changed according to a condition other than the above-described environment changes.

Here, when operating the input 13 step by step, it may be a unit in the vehicle that may transfer multi-step manipulation input values, for example, may be a switch in the vehicle to be operated step by step. For example, the input 13 may be a trip switch (generally provided in a steering wheel) connected to a trip computer 14 of the vehicle.

Accordingly, when the user manipulates the trip switch 13, the trip computer 14 receives a signal according to the manipulation input values of the trip switch 13 and transfers the signal to the controller 20. Then, the controller 20 adjusts the reference value according to the signal by the manipulation input values step by step, and thus, the reference value stored in the controller 20 may be changed according to a manipulation input by the user (the reference value according to the manipulation input by the user is newly stored).

Then, display information (a user set screen and the like) for changing the reference value is displayed on a display in a cluster, and a driver may set the reference value to a desired stage by manipulating the input 13 while identifying the changed state of the reference value through the display.

An external unit (i.e., the input unit) connected wirely or wirelessly to the vehicle, for example, a vehicle diagnosing unit may be used as the input 13 instead of the switch in the vehicle to variably set the reference value.

The controller 20 compares the set reference value with an irradiance detected by the auto light sensor 12 and determines a switching-on/off time point from the comparison result to control switching-on/off of the vehicular lamp 40. As a result, the auto light system according to an embodiment of the present invention may control driving of the vehicular lamp 40 according to the reference value adjusted by the user.

FIGS. 7A and 7B are views showing an example of allowing a user to change and select a switching-on/off time point of an auto light system by stages, and an example of varying the switching-on/off time point by three stages.

As shown, a reference value of the controller by which a switching-on time point is determined and a reference value of the controller by which a switching-off time point are adjusted independently, and the reference values for switching-on/off is increased or decreased to predetermined values of the three stages to change the switching-on time point and the switching-off time point.

Although the present disclosure has been illustrated and described with reference to the specific embodiment, it will be apparent to those skilled in the part to which the present invention pertains that the present invention can be variously modified and changed without departing from the spirit of the present invention claimed in the claims.

What is claimed is:

1. An auto light system comprising:
an auto light sensor configured to receive light and detect an irradiance of the light;
a controller configured to compare the irradiance detected by the auto light sensor with a reference value to switch on and off a vehicle lamp; and
an input provided such that a user performs manipulation for changing the reference value,
wherein if the user performs the manipulation for changing the reference value through the input, the controller receives a signal according to the manipulation by the user, changes the reference value, and stores the changed reference value.

2. The auto light system of claim 1, wherein the input and the controller are provided such that the reference value is changed into a set value by steps according to the manipulation of the user.

3. The auto light system of claim 1, wherein the input is provided in a vehicle such that the manipulation for changing the reference value is performed.

4. The auto light system of claim 1, wherein the input is an external unit provided such that the manipulation for changing the reference value is performed and connected to a vehicle by wire or wireless.

5. The auto light system of claim 1, wherein the auto light sensor has a light receiver for ultraviolet rays configured to receive light at an ultraviolet ray wavelength band and outputting an electrical signal as the light receiver for receiving light.

6. The auto light system of claim 5, wherein the auto light sensor comprises a transparent window for transmitting the ultraviolet rays and transferring the ultraviolet rays to the light receiver in a sensor cover.

7. A method of controlling an auto light system, the method comprising steps of:
performing manipulation for changing a reference value by a user through an input;
receiving a signal according to the manipulation by the user, changing the reference value, and storing the changed reference value by a controller;
comparing an irradiance detected by an auto light sensor with the changed reference value to determine a time point for switching on or off of a vehicle lamp and output a control signal for switching on or off of the vehicle lamp by the controller; and
switching on or off the vehicle lamp according to the control signal output by the controller.

8. The method of claim 7, wherein the input and the controller are provided such that the reference value is changed into a set value by steps according to the manipulation of the user.

9. The method of claim 7, wherein the input is provided in a vehicle such that the manipulation for changing the reference value is performed.

10. The method of claim 7, wherein the input is an external unit provided such that the manipulation for changing the reference value is performed and connected to a vehicle by wire or wireless.

11. The method of claim 7, wherein a light receiver of the auto light sensor receives light of an ultraviolet ray wavelength band and outputs an electrical signal according to a received ultraviolet ray.

12. The method of claim 11, wherein the light receiver of the auto light sensor receives light transmitted through a transparent window provided in a sensor cover and outputs the electrical signal according to the received light.
